(19) United States
(12) Patent Application Publication
(10) Pub. No.: US 2002/0104222 A1
(43) Pub. Date: Aug. 8, 2002

(54) Knife for removing the hide of an animal and method therefor

(76) Inventor: Larry Dean Jay, Kingman, AZ (US)

Correspondence Address: WEISS & MOY PC, 4204 NORTH BROWN AVENUE, SCOTTSDALE, AZ, 85251, US

(21) Appl. No.: 10/057,418

(22) Filed: Jan. 25, 2002

Related U.S. Application Data
(60) Provisional application No. 60/266,567, filed on Feb. 6, 2001.

(51) Int. Cl. B26B 3/00

(52) U.S. Cl. 30/294; 30/314; 30/353

(57) ABSTRACT

A gaming knife to be used to skin the hide of an animal is disclosed. The gaming knife has a handle section which is ergonomically designed to be comfortably held in a hand of a user. The handle section further is designed to allow a wrist of the user to be straight when using the gaming knife to skin the hide off of the carcass. An oval shape blade coupled to the handle section. The oval shaped blade is beveled on one side to cut and lift the hide away from the animal.

### RELATED APPLICATIONS

This patent application is claiming the benefit of the U.S. Provisional Application having an application number of 60/266,567, filed Feb. 6, 2001, in the name of Larry Dean Jay, and entitled “A KNIFE FOR REMOVING THE HIDE OF AN ANIMAL”.

### BACKGROUND OF THE INVENTION

1. Field of the Invention

This invention relates to knives and, more specifically, to a knife having a short rounded blade for removing the hide off of an animal.

2. Description of the Prior Art

Game animals harvested in the field must be dressed quickly to retard spoilage and preserve the meat for later consumption. As a general rule, the faster the meat cools from normal body temperature to typical refrigerator temperature, the slower the rate of spoilage and the more palatable the meat. Therefore, hunters routinely skin and gut the animal in the field (i.e., field dressing) or transport the carcass to a butcher as soon as possible.

Various knives have been developed in the past for the cleaning and dressing of game animals. When removing the hide from an animal, skinning cuts are made by grasping the handle of the knife and pivoting the wrist to produce controlled strokes approximately in the plane of the blade. Most hunters generally use a conventional hunting knife which has a long thin blade. However, when using a straight blade, it is difficult to cut through the hide of the animal without puncturing the viscera, which quickly renders the meat unpalatable or puncturing and damaging the hide.

Another problem with most conventional hunting knives is that the handle on the knife is not ergonomic. Most handles are generally straight and do not conform to the shape of the user's hand. Thus, most knives are difficult to hold while performing cutting motions when skinning the carcass.

Therefore, a need existed to provide an improved game knife. The improved game knife will have a unique blade which will cut and lift the hide of the animal when skinning the carcass. The improved game knife will further have an ergonomic handle which will allow the user to better hold the knife when skinning the carcass.

### SUMMARY OF THE INVENTION

In accordance with one embodiment of the present invention, it is an object of the present invention to provide an improved game knife will have a unique blade which will cut and lift the hide of the animal when skinning the carcass.

It is another object of the present invention to provide an improved game knife will further have an ergonomic handle which will allow the user to better hold the knife when skinning the carcass.

### BRIEF DESCRIPTION OF THE EMBODIMENTS

In accordance with one embodiment of the present invention a gaming knife to be used to skin the hide of an animal is disclosed. The gaming knife has a handle section. An oval shape blade is coupled to the handle section.

In accordance with another embodiment of the present invention a gaming knife to be used to skin the hide of an animal is disclosed. The gaming knife has a handle section which is ergonomically designed to be comfortably held in a hand of a user. The handle section is further designed to allow a wrist of the user to be straight when using the gaming knife to skin the hide off of the carcass. An oval shape blade is coupled to the handle section. The oval shaped blade is beveled on one side in order to cut and lift the hide away from the animal.

In accordance with another embodiment of the present invention, a method of providing a gaming knife to be used to skin the hide of an animal is disclosed. The method comprises: providing a handle section which is ergonomically designed to be comfortably held in a hand of a user and to allow a wrist of the user to be straight when using the gaming knife to skin the hide off of the animal; and providing an oval shape blade coupled to the handle section wherein the oval shaped blade is beveled on one side in order to cut and lift the hide away from the animal.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is an elevated perspective view of the gaming knife of the present invention.

FIG. 2 is a rear view of the blade section of the gaming knife depicted in FIG. 1.

FIG. 3 is a side view of the gaming knife depicted in FIG. 1 taken along lines 3-3.

### DETAILED DESCRIPTION OF THE PREFERRED EMBODIMENT

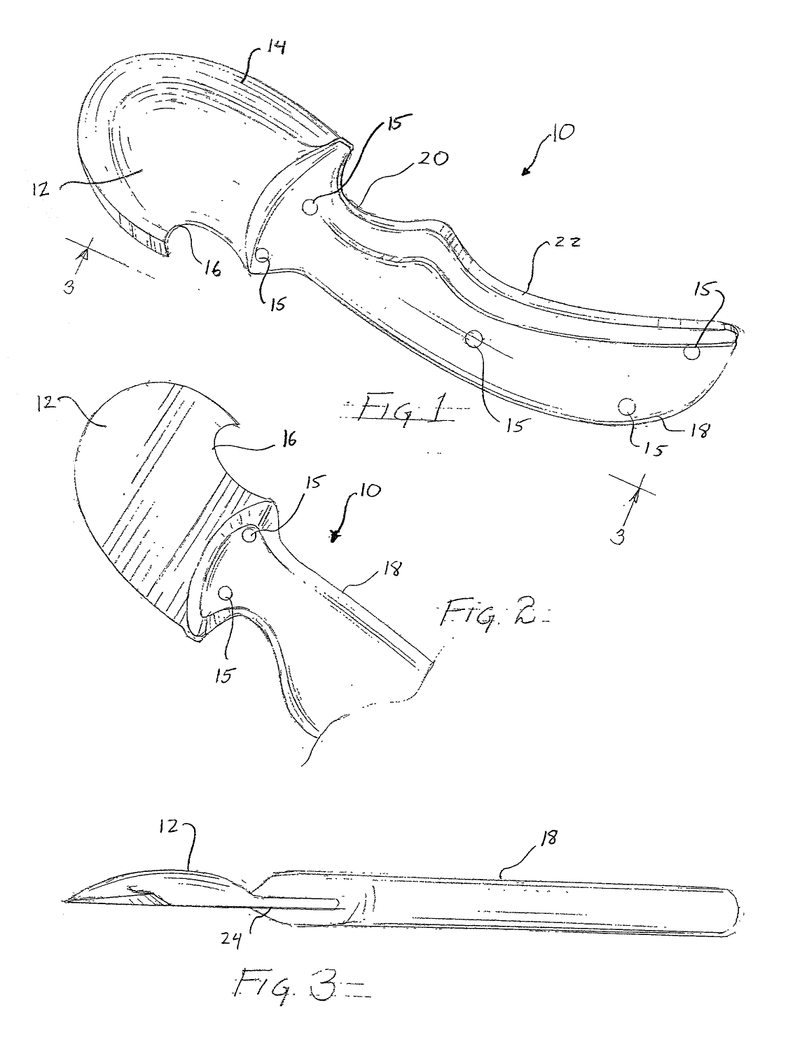

Referring to FIGS. 1-3 wherein like numerals and symbols represent like elements, the gaming knife 10 of the present invention is shown. The gaming knife 10 has a rounded blade section 12. The blade section 12 is generally oval in shape. The oval shape blade section 12 is generally wider than most conventional straight blades. The wider and rounded blade section 14 makes it easier to cut the hide while skinning the carcass. Conventional straight blades generally have a sharp tip on a top section of the blade. The sharp tip of conventional blades have a tendency to puncture the hide when skinning the carcass. Conventional straight blades are also generally longer than the rounded blade section 14 of the present invention. The longer conventional straight blades are less sturdy and have a tendency to bend when field dressing the carcass. Furthermore, the longer conventional straight blades cause the user to have less control when making long cutting strokes when skinning the hide off of a carcass.

The outer edges 14 of the blade section 12 is slightly beveled on one side. In other words, the angle of the grind 14 is on one side of the blade section 12. By having the angle of grind 14 on one side the blade section 12, the blade section 12 is able to cut and lift the hide away from the carcass. Furthermore, by having the angle of grind 14 on one side, the blade section 12 is able to hold a better edge and thus last longer. Since the angle of grind 14 is only on one side of the blade section 12, the blade section 12 is able to last longer. This is due to the fact that when the blade section 12 starts to get dull, only one side of the blade section 12 needs to be sharpened. This will help to ensure a longer blade section 12 life since both sides of the blade section 12 do not have to be sharpened.

The blade section 14 has a “J” shaped hook member 16 located on one side of the blade section 12. The “J” shaped hook member 16 has multiple uses. The use of the “J” shaped hook member 16 depends on whether the “J” shaped hook member 16 is sharpened or is dull. If sharpened, the “J” shaped hook member 16 may be used as a gut hook. The gut hook would be used to cut and remove entrails from the carcass during field dressing. If the “J” shaped hook member 16 is dull, the “J” shaped hook member 16 could be used as a simple pick. The “J” shaped hook member 16 could also be used as a thumb holder if the “J” shaped hook member 16 is dull. The thumb holder would be a place for the user to gain additional leverage when using the gaming knife 10 to skin the hide off of the carcass.

The blade section 14 is coupled to a handle section 18. In the embodiment depicted in the Figures, one or more fastening elements 15 are use to secure the blade section 14 to the handle section 18. However, this should not be seen as to limit the scope of the present invention. The blade section 14 could be coupled to the handle section in numerous other manners. For example, a channeling 24 could be cut in a top are of the handle section 18. The blade section 14 could then be inserted into the channeling 24 of the handle section 18 and secured by some type of adhesive.

The handle section 18 is ergonomically designed to be comfortably held in the hand of the user. The handle section 18 is also designed so that the user can keep his wrist straight when using the gaming knife 10 to skin the hide off of the carcass. With conventional gaming knives, the user must pivot the wrist while skinning the carcass. However, with the handle section 18, the user can keep his wrist straight and make straight cuts. The blade section 14 will then cut and lift the hide away from the carcass.

The handle section 18 has a first indented area 20. The indented area 20 on the handle section 18 is used for placement of the index finger of the user. Below the indented area 20 is a rounded area 22. The rounded area 22 is an area to be used for placement of the other fingers when using the gaming knife 10. These two areas 20 and 22 help the user to comfortably grip and hold the gaming knife 10

The handle section 18 could be made out of a single member or multiple members. If multiple members are used, fastening members 15 would be used to couple the multiple members of the handle section together. The handle section 18 could have, a rubber type of slip resistant cover over the handle section 18. This will help to ensure that the user gets a good grip on the gaming knife 10 so that the gaming knife 10 will not slip out of the hand of the user.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A gaming knife to be used to skin the hide of an animal comprising, in combination:
a handle section; and
an oval shape blade coupled to the handle section.

2. A gaming knife to be used to skin the hide of an animal in accordance with claim 1 wherein the handle section is shaped to keep a wrist of a user straight when using the gaming knife to skin the hide off of the animal.

3. A gaming knife to be used to skin the hide of an animal in accordance with claim 1 wherein the handle section is ergonomically designed to be comfortably held in a hand of a user.

4. A gaming knife to be used to skin the hide of an animal in accordance with claim 1 wherein the handle section comprises:
a slightly curved member having a top section with a width approximately equal to the oval shaped blade;
a first indented area located below the top section for placement of an index finger of the user; and
a rounded elliptical area located below the first indented area for placement of other fingers of the user when using the gaming knife.

5. A gaming knife to be used to skin the hide of an animal in accordance with claim 1 further comprising a slip resistance cover coupled to the handle section.

6. A gaming knife to be used to skin the hide of an animal in accordance with claim 1 wherein the handle section is a comprised of a single member.

7. A gaming knife to be used to skin the hide of an animal in accordance with claim 1 wherein the handle section is comprised of:
a plurality of members; and
fasteners for coupling the plurality of members together.

8. A gaming knife to be used to skin the hide of an animal in accordance with claim 1 wherein the oval shaped blade is beveled on one side to cut and lift the hide away from the animal.

9. A gaming knife to be used to skin the hide of an animal in accordance with claim 1 wherein the oval shaped blade has a “J” shaped hook member located on one side of the oval shaped blade.

10. A gaming knife to be used to skin the hide of an animal comprising, in combination:
a handle section which is ergonomically designed to be comfortably held in a hand of a user and to allow a wrist of the user to be straight when using the gaming knife to skin the hide off of the animal; and
an oval shape blade coupled to the handle section wherein the oval shaped blade is beveled on one side to cut and lift the hide away from the animal.

11. A gaming knife to be used to skin the hide of an animal in accordance with claim 10 wherein the handle section comprises:
a slightly curved member having a top section with a width approximately equal to the oval shaped blade;
a first indented area located below the top section for placement of an index finger of the user; and
a rounded elliptical area located below the first indented area for placement of other fingers of the user when using the gaming knife.

12. A gaming knife to be used to skin the hide of an animal in accordance with claim 10 further comprising a slip resistance cover coupled to the handle section.

13. A gaming knife to be used to skin the hide of an animal in accordance with claim 10 wherein the oval shaped blade has a “J” shaped hook member located on one side of the oval shaped blade.

14. A method of providing a gaming knife to be used to skin the hide of an animal comprising:
providing a handle section which is ergonomically designed to be comfortably held in a hand of a user and to allow a wrist of the user to be straight when using the gaming knife to skin the hide off of the animal; and
providing an oval shape blade coupled to the handle section wherein the oval shaped blade is beveled on one side to cut and lift the hide away from the animal.

15. The method of claim 14 wherein the step of providing a handle section further comprises:
providing a slightly curved member having a top section with a width approximately equal to the oval shaped blade;
providing a first indented area located below the top section for placement of an index finger of the user; and
providing a rounded elliptical area located below the first indented area for placement of other fingers of the user when using the gaming knife.

16. The method of claim 15 further comprising providing a slip resistance cover coupled to the handle section.

17. The method of claim 14 wherein the step of providing an oval shaped blade further comprises providing a “J” shaped hook member located on one side of the oval shaped blade.
